(19) United States
(12) Patent Application Publication
(10) Pub. No.: US 2024/0181459 A1
(43) Pub. Date: Jun. 6, 2024

(54) LIQUID STORAGE CAVITY

(71) Applicant: Osler Diagnostics Limited, Oxford (GB)

(72) Inventors: Mark HYLAND, Oxford (GB); Nuno REIS, Oxford (GB); Mark YEOMAN, Oxford (GB); Richard LUXTON, Oxford (GB); Barry LILLIS, London (GB); Stuart MAY, Oxford (GB)

(21) Appl. No.: 18/553,188

(22) PCT Filed: Apr. 1, 2022
(86) PCT No.: PCT/EP2022/058810

§ 371 Date: Sep. 28, 2023

(30) Foreign Application Priority Data
Apr. 1, 2021 (GB) 2104784.0
Dec. 23, 2021 (GB) 2118918.8

(51) Int. Cl. B01L 3/00

(52) U.S. Cl. CPC B01L 3/52; B01L 2200/026; B01L 2200/16

(57) ABSTRACT

Embodiments described herein relate to a liquid storage cavity, comprising: a base; one or more walls extending from the base, wherein the liquid storage cavity has a volume defined by the base and the one or more walls; and a periphery at which the one or more walls are joined to the base, wherein at least a portion of the periphery includes a peripheral recess defined by the base and at least one of the one or more walls, wherein the peripheral recess is configured to house a volume of liquid.

### FIELD

The present disclosure relates to a liquid storage cavity, such as a liquid storage capsule or a chamber.

### BACKGROUND

Point-of-care diagnostic devices can include cavities such as chambers and/or capsules for storing liquids used in diagnostic tests. For example, capsules may be used to store reagents used in certain diagnostic tests. As another example, a mixing chamber may be implemented, in order to allow mixing of solutions (e.g. dilution of a sample). Such chambers and/or capsules typically include an outlet, allowing the liquid to be transferred to a different component of the device. For example, a solution may be transferred to a flow cell, where an electrochemical measurement is carried out.

It is inevitable that the chambers and/or capsules used in a diagnostic device include a quantity of air. Accordingly, there is a risk that the liquid flowing through the outlet of the chamber/capsule may include one or more air bubbles. Air bubbles are undesirable in point-of-care diagnostic devices, because they can interfere with measurements carried out on a solution in a flow cell. For example, an electrochemical measurement may provide an incorrect reading if an air bubble is positioned on one of the electrodes within the flow cell.

Accordingly, there exists a need for an improved liquid storage cavity that reduces or prevents air bubbles in liquid flowing out of the cavity.

By preventing or reducing bubbles in the liquid flow, a greater proportion of the liquid within the cavity may be removed, prior to bubble formation. This means that, when a given quantity of liquid is required, a smaller liquid storage cavity (chamber, capsule, etc.) may be implemented. This is beneficial because real-estate on point-of-care diagnostic devices is often constrained.

### SUMMARY

This summary introduces concepts that are described in more detail in the detailed description. It should not be used to identify essential features of the claimed subject matter, nor to limit the scope of the claimed subject matter.

According to one aspect of the present disclosure, there is provided a liquid storage cavity, comprising: a base; one or more walls extending from the base, wherein the liquid storage cavity has a volume defined by the base and the one or more walls; and a periphery at which the one or more walls are joined to the base, wherein at least a portion of the periphery includes a peripheral recess defined by the base and at least one of the one or more walls, wherein the peripheral recess is configured to house a volume of liquid.

The volume of liquid housed within the elongate peripheral recess provides a continuous fluid path around the periphery (or portion thereof) of the cavity. This means that liquid can be drawn from the elongate peripheral recess to an outlet of the cavity, provided that a liquid bridge can be established between the outlet and the elongate peripheral recess. This allows for continuous liquid flow out of the cavity outlet, without air bubbles being introduced into the liquid flow.

The at least one of the one or more walls may extend outwardly from an interior of the liquid storage cavity to define the peripheral recess. The at least one of the one or more walls may comprise: a first wall portion and a second wall portion, wherein the first wall portion extends between the base and the second wall portion around the portion of the periphery; wherein the second wall portion extends from the first wall portion in a direction away from the base.

The first wall portion may define a fillet between the second wall portion and the base. The radius of the fillet defined by the first wall portion may be between 0.15 mm and 1 mm. This range of fillet radii is useful for certain liquids by maintaining a continuous liquid feed within the peripheral recess (without breakage of the liquid within the peripheral recess), without retaining too much liquid within the peripheral recess following emptying of the liquid storage cavity. Preferably, the radius of the fillet defined by the first wall portion may be between 0.2 mm and 0.6 mm.

The first wall portion may extend at an acute angle between the base and the second wall portion, such that the peripheral recess has a triangular cross-section. The acute angle between the first wall portion and the base may be less than or equal to 45 degrees. The first wall portion may extend laterally beyond a join between the first wall portion and the second wall portion by a distance of less than or equal to 0.5 mm. These bounds on the angle and distance of the first wall portion are useful for certain liquids by maintaining a continuous liquid feed within the peripheral recess (without breakage of the liquid within the peripheral recess), without retaining too much liquid within the peripheral recess following emptying of the liquid storage cavity.

The first wall portion may comprise a first part and a second part; wherein the first part of the first wall portion is joined to the second wall portion and extends outwardly from an interior of the liquid storage cavity in a direction substantially parallel to the base; and the second part of the first wall portion extends between the first part and the base, such that the elongate recess has a quadrilateral cross-section. The first part of the first wall portion may have a width of less than or equal to 0.5 mm. The second part of the second wall portion may have a height of less than or equal to 0.5 mm. These bounds on the angle and distance of the first wall portion are useful for certain liquids by maintaining a continuous liquid feed within the peripheral recess (without breakage of the liquid within the peripheral recess), without retaining too much liquid within the peripheral recess following emptying of the liquid storage cavity.

The liquid storage cavity may be a capsule. The height of the liquid storage cavity may be less than or equal to 5 mm. This range of cavity heights results in a liquid column between upper and lower internal surfaces of the cavity, which increases the volume of bubble-free liquid that can be emptied from the cavity when the cavity is upside-down (i.e. with its outlet on a top surface of the cavity). Preferably, the height of the liquid storage cavity may be less than or equal to 3.5 mm.

The angle between the second wall portion and the base may be less than 55 degrees. This reduces liquid pooling and droplet formation within the cavity when the cavity is emptied in the upside-down orientation. The second wall portion may define an upper surface of the cavity that is non-parallel to the base. This further reduces the tendency for liquid pooling or droplet formation during upside-down emptying. The width of the cavity may be no more than 2.5 times the height of the cavity.

The second wall portion may extend away from the base in a direction substantially perpendicular to the base. This maximises the volume of the cavity, for a given footprint of the cavity.

The peripheral recess may extend around the entire periphery of the liquid storage cavity. This allows liquid to be drawn into the peripheral recess around any part of the cavity periphery.

The liquid storage cavity may further comprise an outlet in the base. The outlet may be coincident with the portion of the periphery. Providing an outlet that is coincident with the periphery means that a liquid bridge is not required between the outlet and the periphery, in order to extract liquid from the chamber.

According to another aspect of the present disclosure, there is provided a method of removing liquid from a liquid storage cavity, the method comprising: providing a liquid storage cavity according to the first aspect; providing an inlet to the liquid storage cavity and an outlet in the base of the liquid storage cavity; orienting the liquid storage cavity so that the outlet is positioned on a top side of the liquid storage cavity; and supplying gas via the inlet to expel liquid out of the outlet.

The peripheral recess of the liquid storage cavity allows the liquid storage cavity to be emptied, even when the cavity is in an upside-down configuration (i.e. when the outlet is positioned on a top side of the liquid storage cavity).

Providing the outlet in the base of the liquid storage cavity may comprises providing a liquid storage cavity comprising an outlet in the base. Alternatively, providing the outlet in the base of the liquid storage cavity may comprise creating the outlet in the base of the liquid storage cavity.

### BRIEF DESCRIPTION OF FIGURES

Specific embodiments are described below by way of example only and with reference to the accompanying drawings, in which:

FIG. 1A is a schematic section view through a liquid storage cavity having a peripheral recess, wherein the liquid storage cavity is in the process of being emptied.

FIG. 1B is a schematic section view through the liquid storage cavity in FIG. 1A after being emptied.

FIG. 2A is an isometric view of a liquid storage capsule.

FIG. 2B is a top view of the liquid storage capsule shown in FIG. 2A.

FIG. 2C is a side view of the liquid storage capsule shown in FIG. 2A.

FIG. 2D is a simulation showing liquid within the liquid storage capsule shown in FIG. 2A.

FIG. 3A is a simulation showing an isometric view of liquid remaining within a liquid storage capsule after a first time period.

FIG. 3B is a top view of the simulation shown in FIG. 3A.

FIG. 4A is a simulation showing an isometric view of liquid remaining within the liquid storage capsule simulated in FIG. 3A after a second time period.

FIG. 4B is a top view of the simulation shown in FIG. 4A.

FIG. 4C is a section view through line A-A in FIG. 4B.

FIG. 4D is a section view through line B-B in FIG. 4B.

FIG. 5A is a simulation showing an isometric view of liquid remaining within the liquid storage capsule simulated in FIG. 3A after a third time period.

FIG. 5B is a section view through line A-A in FIG. 4B after the third time period.

FIG. 5C is a section view through line B-B in FIG. 4B after the third time period.

FIG. 6A is a simulation showing an isometric view of a liquid volume within a chamber after a first time period.

FIG. 6B is a top view of the simulation shown in FIG. 6A.

FIG. 6C is a section view through line A-A in FIG. 6B.

FIG. 7A is a simulation showing an isometric view of a liquid volume within the chamber simulated in FIG. 6A after a second time period.

FIG. 7B is a section view through line A-A in FIG. 6B after the second time period.

FIGS. 8A-8C each show simulated results of a cross-sectional area of liquid within a peripheral recess of a liquid storage cavity, wherein the peripheral recess is defined by a fillet.

FIG. 9 is a section view through a liquid storage cavity having a peripheral recess defined by a chamfer.

FIGS. 10A-10E each show simulated results of a cross-sectional area of liquid within a peripheral recess of a liquid storage cavity, wherein the peripheral recess is defined by a chamfer.

FIG. 11 is a section view through a liquid storage cavity having a peripheral recess defined by a step.

FIGS. 12A-12F each show simulated results of a cross-sectional area of liquid within a peripheral recess of a liquid storage cavity, wherein the peripheral recess is defined by a step.

FIG. 13A is a section view through a liquid storage cavity having an outlet at the top of the liquid storage cavity.

FIG. 13B is a section view through a further liquid storage cavity having an outlet at the top of the liquid storage cavity.

FIGS. 14A-14C each show simulated results of a cross-sectional area of liquid within a peripheral recess of a liquid storage cavity having an outlet at the top of the liquid storage cavity.

FIG. 15A is a side view of a tool used to deform a liquid storage capsule.

FIG. 15B is a section view through line A-A in FIG. 15A.

FIG. 16 is a flow diagram of a method of removing liquid from a liquid storage cavity.

### DETAILED DESCRIPTION

Implementations of the present disclosure are explained below with particular reference to liquid storage cavities such as capsules and chambers. It will be appreciated, however, that the implementations described herein are applicable to other types of cavity having a base and one or more walls. Although the examples below are described as being of particular utility in point-of-care diagnostic devices (such as microfluidic devices), it will be appreciated that such examples are not limited to implementation in point-of-care diagnostic devices, and may be implemented in other applications in which liquid is stored in a cavity having an outlet.

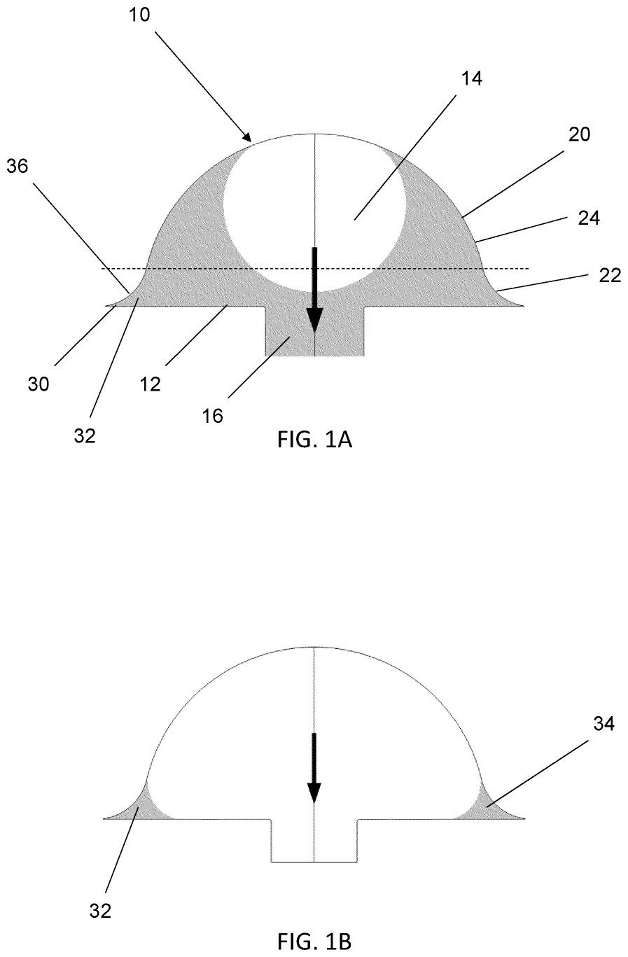

FIG. 1A shows a liquid storage cavity 10 according to the present disclosure. In general terms, the liquid storage cavity 10 has a base 12 and one or more walls 20 (e.g. one wall for a cylindrical cavity, four walls for a cavity with a quadrilateral area, etc.). The one or more walls 20 extend from the base 12. The liquid storage cavity 10 has a volume defined by the base 12 and the one or more walls 20. The liquid storage cavity 10 also has a periphery 30, defined as the join between the one or more walls 20 and the base 12. At least a portion of the periphery 30 (in some examples, the entire periphery) includes a peripheral recess 32 that is defined by the base 12 and at least one of the one or more walls 20. The peripheral recess 32 is configured to house a volume of liquid 34 (e.g. as shown in FIG. 1B).

In the example shown in FIG. 1A, the wall(s) 20 that define the peripheral recess 32 extend outwardly from an interior 14 of the liquid storage cavity 10, thereby defining a wedge or groove-shaped peripheral recess 32 extending laterally from the cavity 10.

In order to define the peripheral recess 32, the walls 20 of the liquid storage cavity 10 shown in FIG. 1A include a first wall portion 22 and a second wall portion 24. The dashed line in FIG. 1A shows the interface between the first wall portion 22 and the second wall portion 24. Specifically, in the example shown in FIG. 1A, the first wall portion 22 has a different curvature to the second wall portion 24. The first wall portion 22 extends between the base 12 and the second wall portion 24 around the portion of the periphery 30 that includes the peripheral recess 32. In the example shown in FIG. 1A, the first wall portion 22 defines a fillet 36 between the second wall portion 24 and the base 12. The second wall portion 24 extends from the first wall portion 22 in a direction away from the base 12.

The volume of liquid 34 housed within the peripheral recess 32 provides a continuous fluid path around the periphery 30 (or portion thereof) of the cavity 10. This means that liquid can be drawn from the peripheral recess 32 to an outlet 16 of the cavity 10, provided that a liquid bridge can be established between the outlet 16 and the peripheral recess 32 (unless the outlet 16 is coincident with the periphery 30, in which case a liquid bridge is not required). Drawing liquid from the peripheral recess 32 to the outlet 16 allows for continuous liquid flow out of the cavity outlet 16, without air bubbles being introduced into the liquid flow.

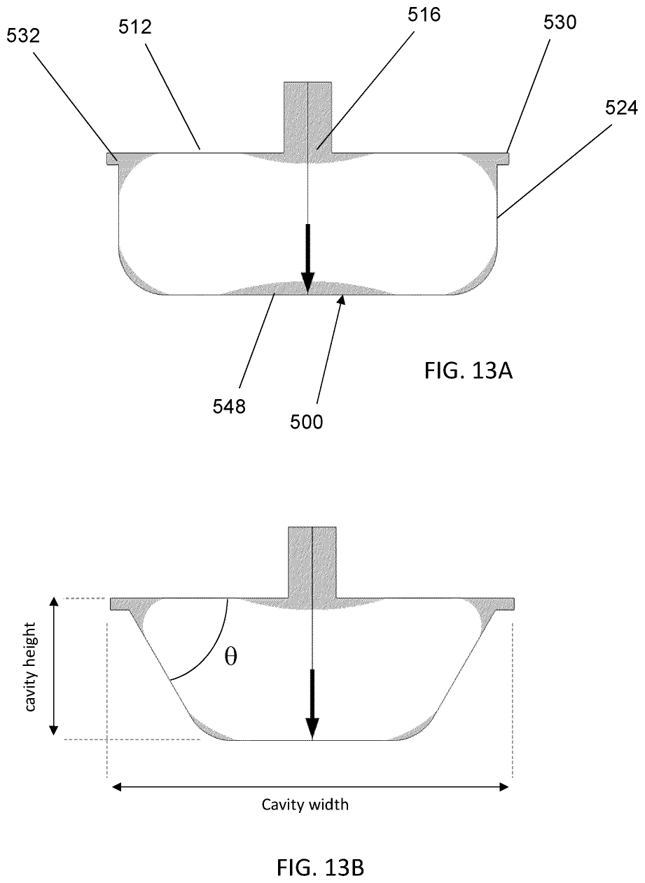

The continuous fluid path within the peripheral recess 32 is formed as a result of the surface tension effects of the solution, and the wetted contact angle of the solution to the wall(s) 20 and base 12 of the cavity. The volume of liquid 34 is drawn into the peripheral recess 32 by capillary action, so that the free-surface energy of the liquid within the cavity 10 is minimised. Specifically, the geometry and dimensions of the peripheral recess 32 provides an energetically favourable scenario that balances the liquid-solid and liquid-gas surface energies, and leads to the formation of a continuous liquid ‘wedge’ within the peripheral recess 32 (e.g. as shown in FIG. 1B). This effect is observed whether the cavity 10 is oriented with its base downwards (e.g. FIG. 1A), or whether the cavity 10 is oriented upside-down, with its base upwards, such that the outlet is in the top of the cavity (e.g. FIG. 13A).

Importantly, the continuous liquid volume 34 within the peripheral recess 32 is not disrupted during liquid flow out of the cavity 10, even when the cavity 10 is only partially filled. This means that the liquid volume 34 arrested within the peripheral recess 32 provides continued guidance for liquid flow out of the cavity 10, during emptying of the cavity 10. The favourable surface energy balance can be exploited by pressurising the cavity 10, in order to provide continuous liquid flow out of the cavity 10. For example, air may be injected into the cavity 10 through an inlet (not shown in FIG. 1A) to the cavity 10. In such an example, air is unable to escape through the outlet 16 until the outlet 16 becomes unobstructed by liquid. A continuous liquid volume can therefore be emptied from the cavity 10 by injecting a corresponding air volume into the cavity 10.

When drawing liquid out of a cavity 10 that is almost empty, the flow rate should be controlled to minimise shear effects on the liquid. If shear forces on the liquid are too high, then the volume of liquid 34 within the peripheral recess 32 will break, meaning that pressurisation of the cavity 10 would need to stop in order for the liquid bridge to be re-formed by capillary action. This is only an issue when the cavity 10 is almost empty, as the liquid bridge is present when the cavity is half-full, for example.

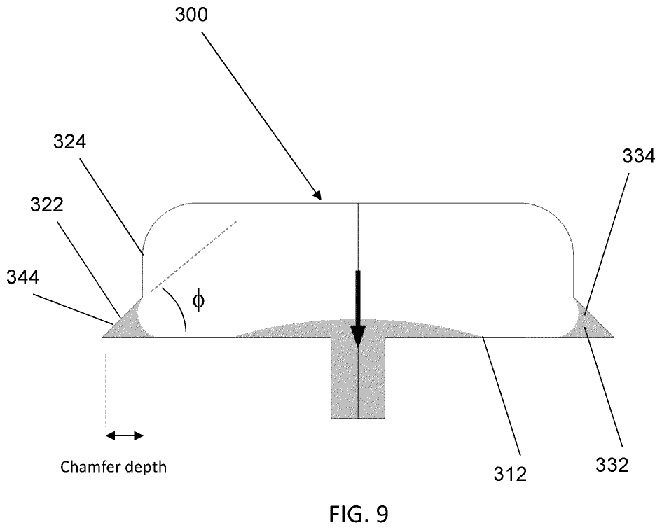

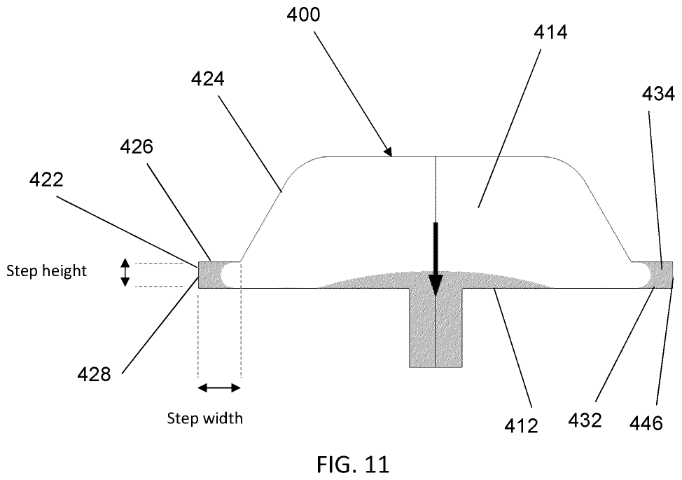

The peripheral recess 32 can take the form of: (i) a fillet 36 (as shown, for example, in FIG. 1A); (ii) a chamfer (as shown, for example, in FIG. 9), which provides a peripheral recess with a triangular cross-section; (iii) a step (as shown, for example, in FIG. 11), which provides a peripheral recess with a quadrilateral cross-section; or (iv) a combination of the foregoing.

Parameters for optimising the size of the peripheral recess 32 are described in more detail below. In general terms, it is preferable for the peripheral recess 32 to be sized so that the steady-state cross-sectional profile of the liquid volume 34 within the peripheral recess 32 is: (i) large enough so that liquid can be drawn from any point along the peripheral recess 32, while maintaining a continuous liquid feed into the peripheral recess 32 from other liquid volumes within the cavity 10; and (ii) small enough so that the volume of liquid 34 remaining within the peripheral recess 32 following emptying of the cavity 10 is not too large, in order to minimise wastage of liquid. Wastage of some volume of liquid is inevitable because the liquid volume 34 will remain trapped in the peripheral recess 32 following emptying of the cavity. This is shown in FIG. 1B, which shows the liquid storage cavity 10 in an emptied state.

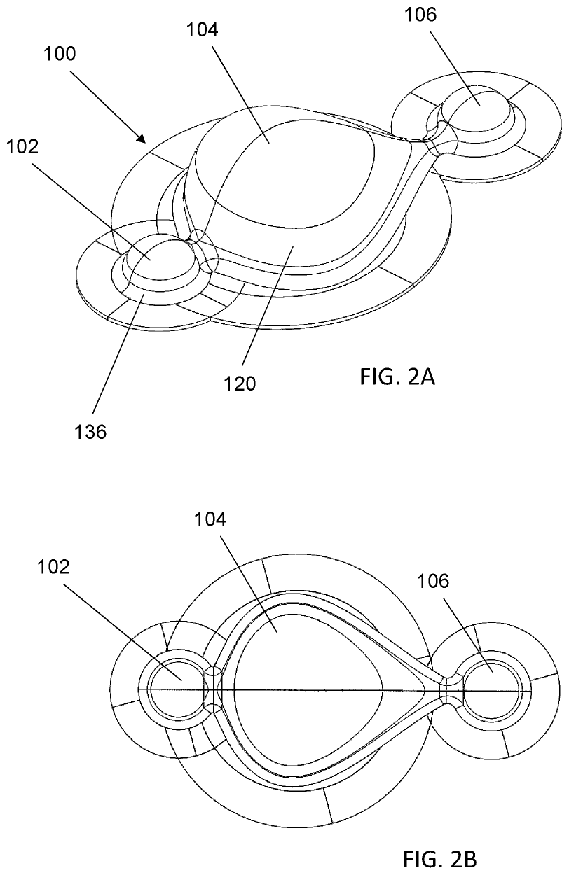

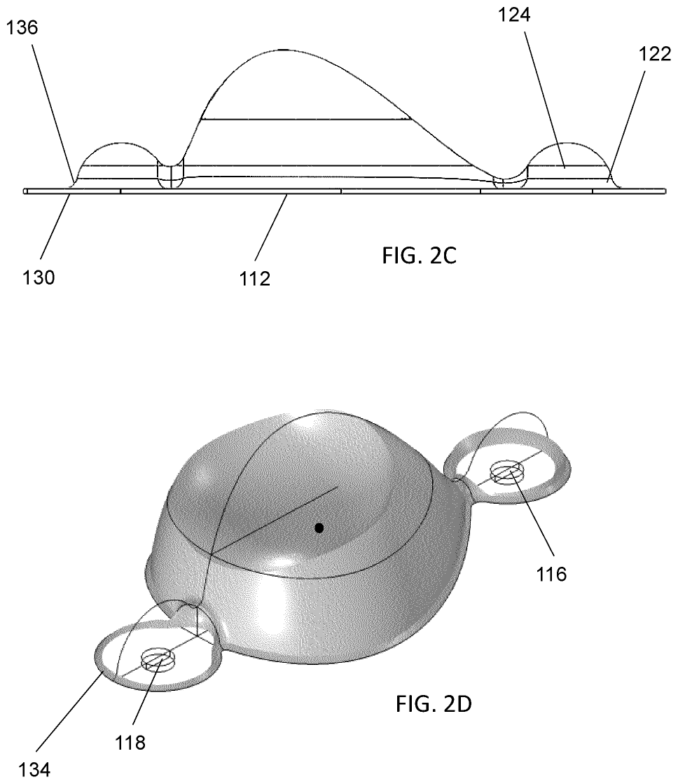

FIGS. 2A to 2C show a liquid storage cavity in the form of a liquid storage capsule 100 to which the peripheral recess shown in FIG. 1A is applied. The liquid storage capsule 100 may be implemented in a point-of-care diagnostic device, such as a microfluidic cartridge, that may be received in an analyser device.

The liquid storage capsule 100 includes three portions: an inlet chamber 102, a liquid storage chamber 104, and an outlet chamber 106. These portions of the liquid storage capsule 100 are defined by a base 112 (shown in FIG. 2C) and a continuous wall 120 of the liquid storage capsule 120. The join between the wall 120 and the base 112 defines a periphery 130 (also shown in FIG. 2C) of the liquid storage capsule 100.

The upper surfaces of the inlet chamber 102 and the outlet chamber 106 can each be deformed by application of a downward force (for example, by an actuator of the analyser device in which the microfluidic cartridge comprising the liquid storage capsule 100 is received). The application of a downward force to the inlet chamber 102 and the outlet chamber 106 deforms the material of the inlet chamber 102 and the outlet chamber 106, such that it is forced into contact with the base 112. Continued application of a downward force ruptures the base 112 beneath the inlet chamber 102 and the outlet chamber 106, thereby creating an inlet 118 and an outlet 116 (as shown in FIG. 2D). It will be appreciated that the inlet 118 and outlet 116 may be created in other ways, such as by actuating puncturing elements disposed beneath the inlet chamber 102 and the outlet chamber 106.

The wall 120 of the liquid storage capsule 100 comprises a first wall portion 122 and a second wall portion 124. The first wall portion 122 extends between the base 112 and the second wall portion 124 around the periphery 130 of the liquid storage capsule 100. The second wall portion 124 extends from the first wall portion 122 away from the base 112. In this example, the second wall portion 124 extends away from the first wall portion 122 to define an upper surface of the liquid storage capsule 100.

The first wall portion 122 provides a fillet 136 between the base 112 and the second wall portion 124. The fillet 136 therefore defines a peripheral recess 132 (best shown in FIG. 2C) that extends around the periphery 130 of the liquid storage capsule 100, such that the peripheral recess is provided at the base of the inlet chamber 102, the liquid storage chamber 104, and the outlet chamber 106.

Liquid is drawn into the peripheral recess by capillary action, thereby forming a ring-shaped volume of liquid 134 around the edge of the inlet chamber 102 and the outlet chamber 106, as shown in FIG. 2D. The volume of liquid 134 provides a continuous path for fluid flow out of the liquid storage capsule 100 through the capsule outlet 116, for example, when air is supplied via a capsule inlet 118, provided that a liquid bridge is provided between the volume of liquid 134 within the peripheral recess and the outlet 116.

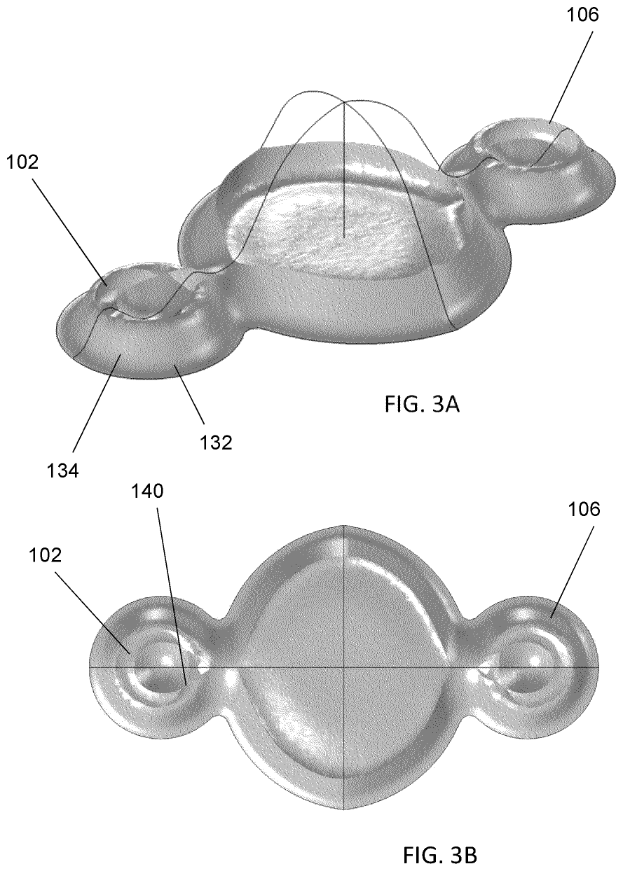

FIGS. 3A and 3B are isometric and top views of a simulated volume of liquid remaining within a liquid storage capsule having a similar geometry to the liquid storage capsule 100 shown in FIGS. 2A to 2C. Although there are minor differences in the geometry of the liquid storage capsules shown in FIGS. 2A to 2C and 3A and 3B (e.g. the dimples in the inlet and outlet chambers), the same reference signs will be used for convenience. The simulation in FIGS. 3A and 3B shows the remaining liquid volume during emptying of the liquid storage capsule 100, after a first time period. FIGS. 3A and 3B show liquid bridges 140 extending between the liquid volume 134 in the peripheral recess 132 and the capsule inlet 118 and outlet 116 (located centrally within the inlet chamber 102 and the outlet chamber 106, respectively).

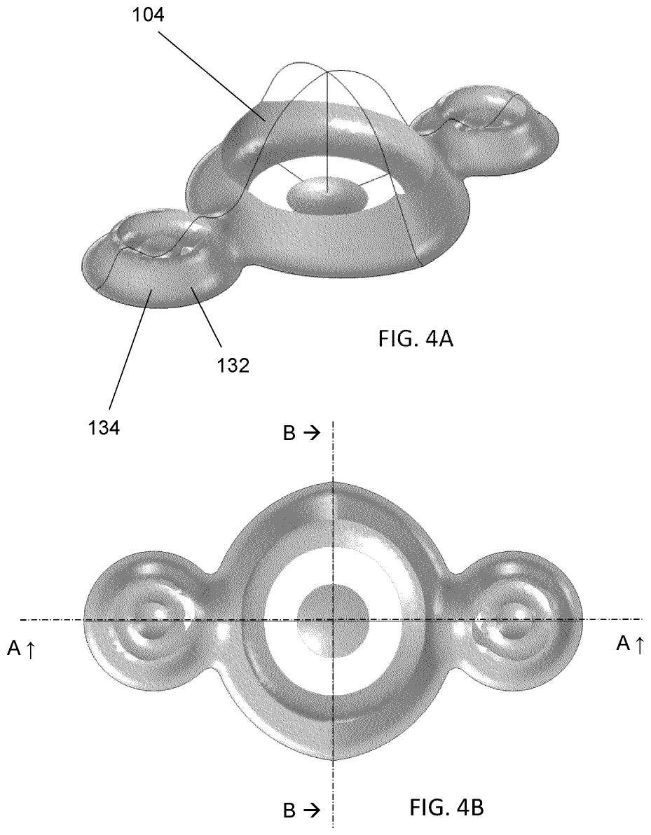

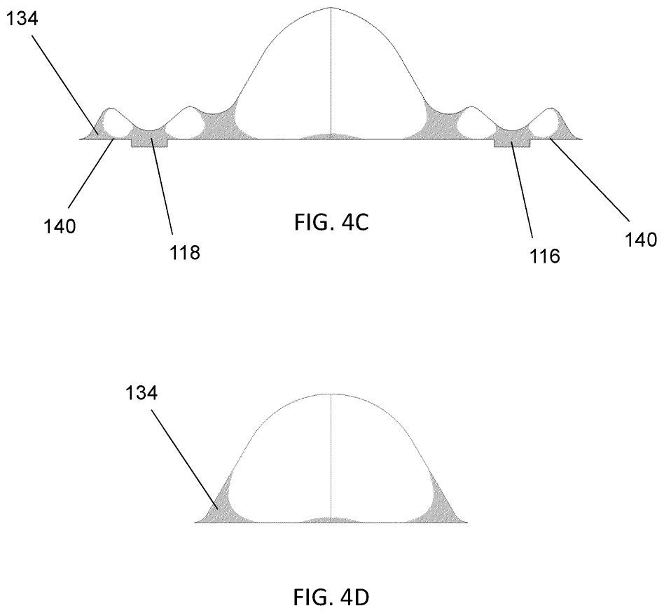

FIGS. 4A to 4D show the remaining liquid volume after a second time period (i.e. later during the emptying operation). As shown in FIGS. 4A to 4D, most of the liquid has been emptied from the liquid storage chamber 104. However, the peripheral recess 132 still houses the liquid volume 134, and the liquid bridges 140 between the liquid volume 134 and the inlet 118 and outlet 116 persist (as best shown in FIGS. 4C and 4D), allowing continued liquid extraction from the liquid storage capsule 100.

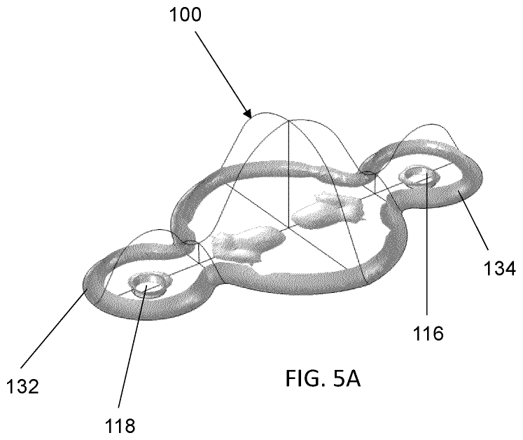

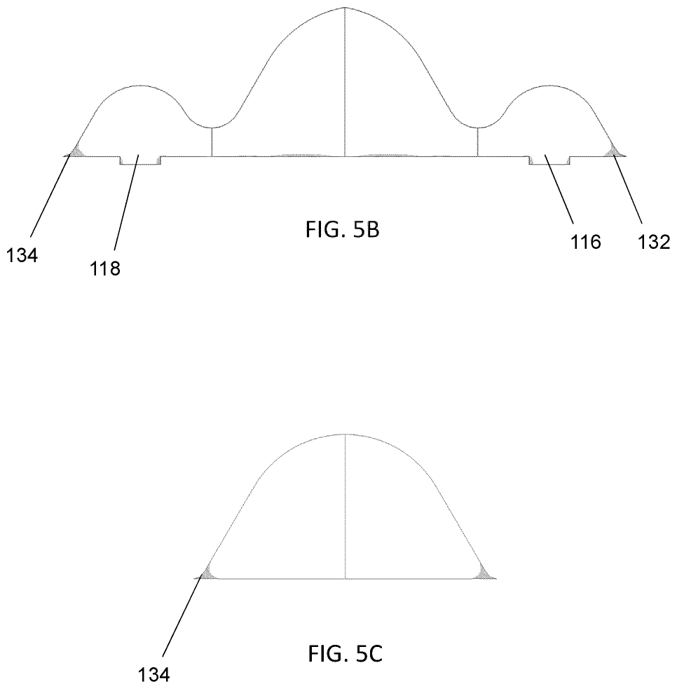

FIGS. 5A to 5C show the remaining liquid volume after a third time period (i.e. even later during the emptying operation). As shown in FIGS. 5A to 5C, most of the liquid has been emptied from the liquid storage capsule 100 as a whole. The liquid bridges 140 between the liquid volume 134 within the peripheral recess 132 and the inlet 118 and outlet 116 have broken, meaning that the continuous liquid flow out of the liquid storage capsule 100 has ended. That is, no further liquid can be extracted without introducing an air bubble between the already-extracted liquid and the remaining liquid. FIGS. 5A to 5C show that the liquid volume 134 within the peripheral recess 132 remains after the emptying operation has ended.

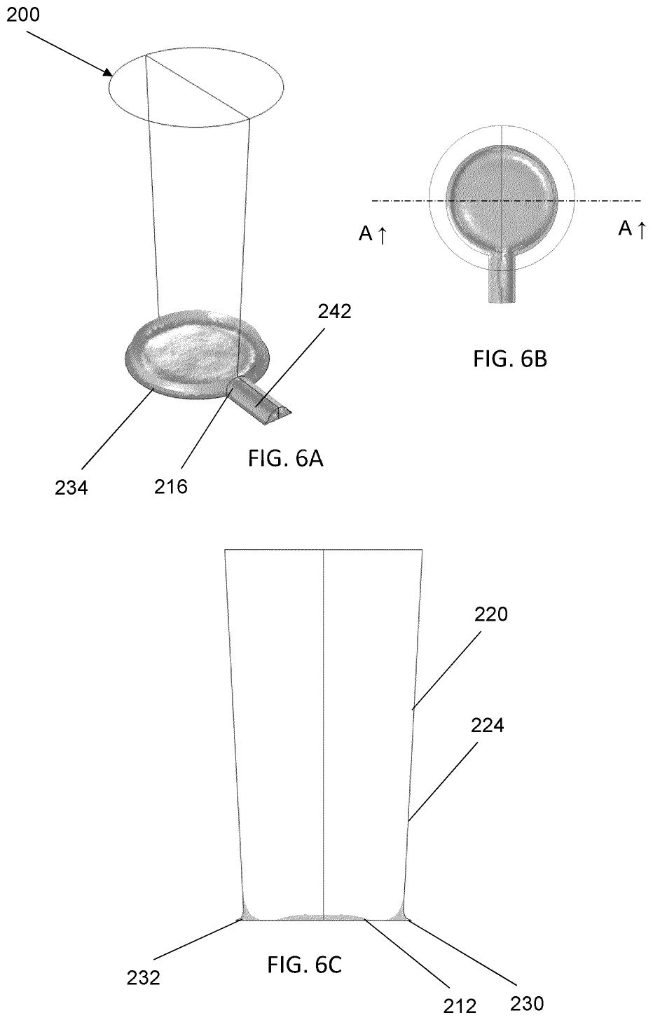

FIGS. 6A to 6C show a simulated volume of liquid remaining within an alternative liquid storage cavity. In particular, the liquid storage cavity simulated in FIGS. 6A to 6C is a cylindrical chamber 200 (shown in outline form only) which may, for example, be implemented as a mixing chamber. The chamber 200 comprises a base 212 and a continuous side wall 220, that join at a periphery 230 of the chamber 200. The second wall portion 224 of the continuous side wall 220 extends perpendicularly to the base 212, such that the chamber 200 has vertical walls. A peripheral recess 232 extends around the periphery 230, and is configured to house a volume of liquid 234.

The chamber 200 includes an outlet 216 that provides an opening in the periphery 230 of the chamber 200. This means that, unlike the example shown in FIGS. 2A to 2D, the outlet 216 is coincident with the periphery 230. The coincidence of the outlet 216 and the periphery 230 means that a liquid bridge is not required between the outlet and the periphery, in order to extract liquid from the chamber 200. The outlet 216 is connected to a channel 242. The chamber 200 also comprises an inlet (not shown), which may, for example, be provided at the upper extent of the side wall 220.

FIGS. 6A to 6C show the remaining liquid volume after a first time period, during emptying of the chamber 200. The volume of liquid 234 within the peripheral recess 232 can clearly be seen. This volume is connected to the liquid that is being extracted via the outlet 216.

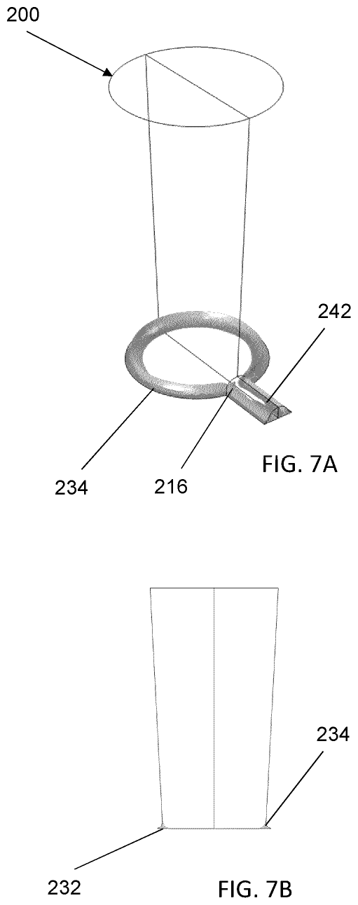

FIGS. 7A and 7B show the remaining liquid volume after a second time period (i.e. later on in the emptying operation). As shown in FIGS. 7A to 7B, most of the liquid has been emptied from the chamber 200. A volume of air is shown in the channel 242 connected to the outlet 216, meaning that no further liquid can be extracted without introducing an air bubble between the already-extracted liquid and the remaining liquid. FIGS. 7A and 7B show that the liquid volume 234 within the peripheral recess 232 remains after the emptying operation has ended.

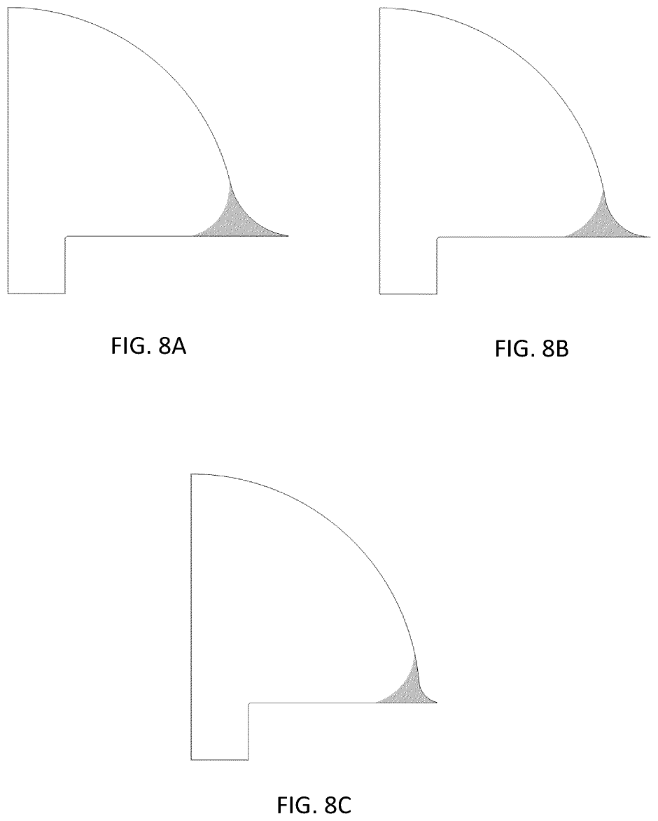

The parameters defining the geometry of the fillet 36 will now be described, with reference to FIGS. 8A to 8C. Preferably, the geometry of the fillet 36 is optimised such that the cross-sectional profile of the liquid volume 34 within the peripheral recess 32 does not go below a threshold cross-sectional area. The threshold value is implemented to ensure that the liquid volume 34 within the peripheral recess 32 does not break. Breakage of the liquid volume 34 would result in an insufficient liquid volume 34 to draw liquid into the peripheral recess 32. The threshold value therefore ensures that liquid can be drawn from any point along the peripheral recess 32, while maintaining a continuous liquid feed from other liquid volumes within the cavity 10. The threshold cross-sectional area may be determined based on the properties of the liquid, such as viscosity, surface tension, and contact angle.

As one example that is applicable for certain liquids having a viscosity of between 0.005 and 0.015 Pa·s, a surface tension of between 0.01 and 0.06 N/m, and wetted contact angles with the cavity walls/base of between 5 and 40 degrees, the threshold cross-sectional area is 0.06 mm². To achieve the threshold cross-sectional area of 0.06 mm², a fillet radius of at least 0.15 mm is required.

It is also desirable to keep the volume of liquid 34 retained within the peripheral recess 32 below an upper bound. This is because the volume of liquid 34 is retained within the peripheral recess 32 after emptying of the cavity 10, meaning that the retained liquid volume 34 cannot be extracted from the cavity 10. The upper bound will be dependent on the threshold cross-sectional area for the particular liquid.

Continuing the example applicable for certain liquids having a viscosity of between 0.005 and 0.015 Pas, a surface tension of between 0.01 and 0.06 N/m, and wetted contact angles with the cavity walls/base of between 5 and 40 degrees, it is preferable for the fillet radius to be no more than 1 mm. A preferred range for the fillet radius for such liquids is between 0.2 mm and 0.6 mm.

FIGS. 8A to 8C are simulations of the liquid volumes retained in peripheral recesses having different fillet radii. The simulations are carried out using the following liquid properties: viscosity of 0.005 Pas, surface tension of 0.018175 N/m, and wetted contact angle of 20 degrees. FIG. 8A is a simulation of a cavity with a fillet radius of 0.6 mm. With a fillet radius of 0.6 mm, the cross-sectional area of the liquid within the peripheral recess was 0.11 mm². FIG. 8B is a simulation of a cavity with a fillet radius of 0.4 mm. With a fillet radius of 0.4 mm, the cross-sectional area of the liquid within the peripheral recess was 0.082 mm². FIG. 8C is a simulation of a cavity with a fillet radius of 0.2 mm. With a fillet radius of 0.2 mm, the cross-sectional area of the liquid within the peripheral recess was 0.063 mm².

The table in Annex 1 shows the cross-sectional area of the liquid volume 34 within the peripheral recess 32 for other combinations of liquid properties. These liquid properties include the direction of gravity. This property is considered because the peripheral recess 32 can facilitate emptying of a cavity “upside-down” (i.e. with the outlet 16 at the top of the cavity 10). The volume of bubble-free liquid emptied from the liquid storage cavity 10 is maximised if the cavity has a sufficiently shallow depth (e.g. no more than 5 mm) such that a vertical liquid column is provided between its upper and lower internal surfaces as a result of the surface tension of the liquid overcoming the force of gravity on the liquid. In the table in Annex 1, a gravity direction of ‘1’ indicates that the outlet 16 is at the bottom of the cavity 10, whereas a gravity direction of ‘-1’ indicates that the outlet 16 is at the top of the cavity 10.

FIG. 9 shows an alternative liquid storage cavity 300, in which the first wall portion 322 extends at an acute angle between the base 312 and the second wall portion 324. This means that the first wall portion 322 provides a chamfer 344 between the base 312 and the second wall portion 324. Accordingly, the peripheral recess 332 has a triangular cross-section.

The geometry of the chamfer 344 can be defined by two properties: the chamfer depth and the chamfer angle, both of which are illustrated schematically in FIG. 9. The chamfer depth is the lateral distance between the join between the first wall portion 322 and the second wall portion 324, and the maximum lateral outward extension of the chamfer 344 (in other words, how far the chamfer 344 extends laterally from the join with the second wall portion 324). The chamfer angle is the angle between the first wall portion 322 and the base 312.

The chamfer 344 retains liquid in the same way as the fillet 36 described above. If the chamfer 344 is too large, then a large liquid volume is retained in the peripheral recess 332, meaning that a proportion of the liquid within the cavity 300 is lost. However, as with the fillet 36, it is preferable for the cross-sectional area of the liquid volume 334 within the peripheral recess 332 to be at least a threshold value.

For example, the threshold cross-sectional area may be 0.06 mm², as with the example given above. In order to achieve this threshold, the chamfer depth should be at least 0.2 mm, and the chamfer angle should be at least 20 degrees. To prevent a large liquid volume being retained in the elongate peripheral recess 332 after emptying, the chamfer depth should be no more than 0.5 mm, and/or the chamfer angle should be no more than 45 degrees.

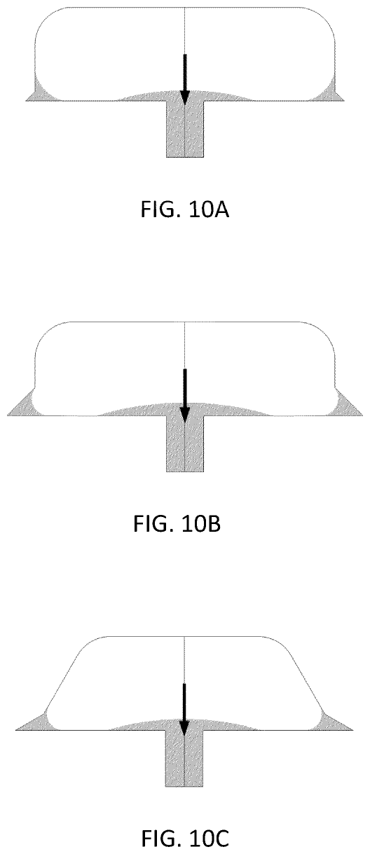

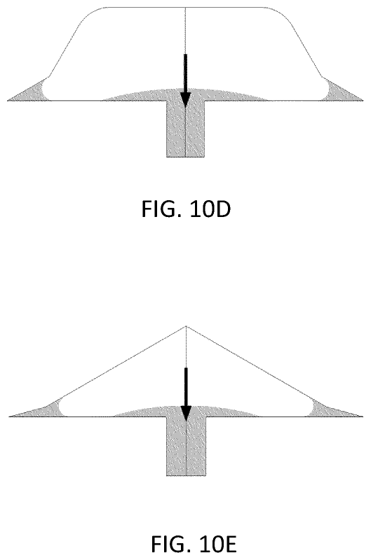

FIGS. 10A to 10E are simulations of the liquid volumes retained in peripheral recesses having different chamfer geometries. The simulations were carried out using the following properties: dynamic viscosity of 0.01 Pas, surface tension of 0.054 N/m, wetted contact angle of 15 degrees, and specific gravity of 1.02. Gravity was in the direction of the arrows shown in FIGS. 10A to 10E. Another parameter varied in these simulations is the angle of the second wall portion 322 to the base 312. Second wall portion angles of 90 degrees (FIGS. 10A and 10B), 60 degrees (FIGS. 10C and 10D) and 30 degrees (FIG. 10E) were simulated.

FIG. 10A is a simulation of a cavity with a chamfer depth of 0.25 mm, a chamfer angle of 45 degrees, and a second wall portion angle of 90 degrees (i.e. such that the second wall portion 324 extends substantially perpendicular to the base 312). With this cavity and chamfer geometry, the cross-sectional area of the liquid within the peripheral recess was 0.220 mm². FIG. 10B is a simulation of a cavity with a chamfer depth of 0.75 mm, a chamfer angle of 45 degrees, and a second wall portion angle of 90 degrees. With this cavity and chamfer geometry, the cross-sectional area of the liquid within the peripheral recess was 0.268 mm². FIG. 10C is a simulation of a cavity with a chamfer depth of 0.75 mm, a chamfer angle of 30 degrees, and a second wall portion angle of 60 degrees. With this cavity and chamfer geometry, the cross-sectional area of the liquid within the peripheral recess was 0.249 mm². FIG. 10D is a simulation of a cavity with a chamfer depth of 1.125 mm, a chamfer angle of 30 degrees, and a second wall portion angle of 60 degrees. With this cavity and chamfer geometry, the cross-sectional area of the liquid within the peripheral recess was 0.276 mm². FIG. 10E is a simulation of a cavity with a chamfer depth of 0.937 mm, a chamfer angle of 27.5 degrees, and a second wall portion angle of 30 degrees. With this cavity and chamfer geometry, the cross-sectional area of the liquid within the peripheral recess was 0.253 mm².

FIG. 11 shows a further alternative liquid storage cavity 400, in which the first wall portion 422 defines a peripheral recess 432 in the form of a step 446. Specifically, the first wall portion 422 comprises a first part 426 that is joined to the second wall portion 424 and extends outwardly from the second wall portion 424 (i.e. outwardly from the interior 414 of the liquid storage cavity 400). The first wall portion 422 also comprises a second part 428 that extends between the first part 426 and the base 412. This means that the first and second parts 426, 428 of the first wall portion 422 define a quadrilateral (e.g. square, rectangular, trapezoidal) cross-section of the peripheral recess 432.

The geometry of the step 446 can be defined by two properties: the width of the step 446 (i.e. the length of the first part 426 of the first wall portion 422), and the height of the step 446 (i.e. the length of the second part 428 of the first wall portion 422). Both of these properties are illustrated schematically in FIG. 11.

The step 446 retains liquid in the same way as the fillet 36 and chamfer 334 described above. If the step 446 is too large, then a large liquid volume is retained in the peripheral recess 432, meaning that a proportion of the liquid within the cavity 400 is lost. However, as with the fillet 36, it is preferable for the cross-sectional area of the liquid volume 434 within the peripheral recess 432 to be at least a threshold value.

For example, the threshold cross-sectional area may be 0.06 mm², as with the example given above. In order to achieve this threshold, the step width should be at least 0.2 mm, and the step height should be at least 0.2 mm. To prevent a large liquid volume being retained in the elongate peripheral recess 332 after emptying, the step width should be no more than 0.5 mm and/or the step height should be no more than 0.5 mm.

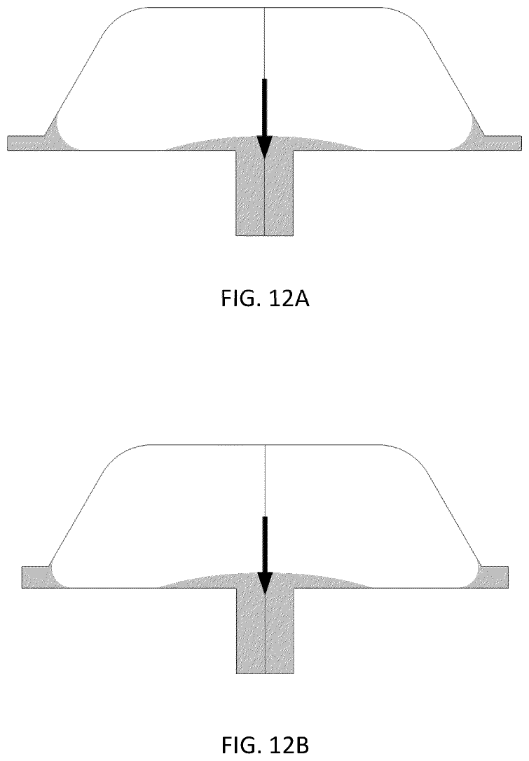

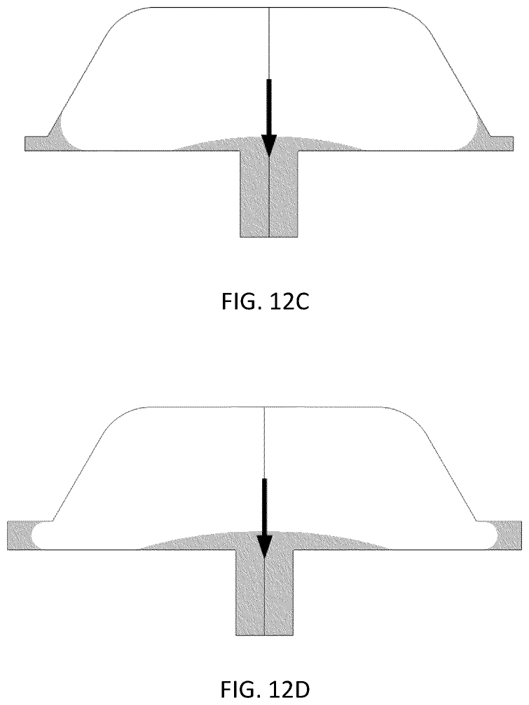

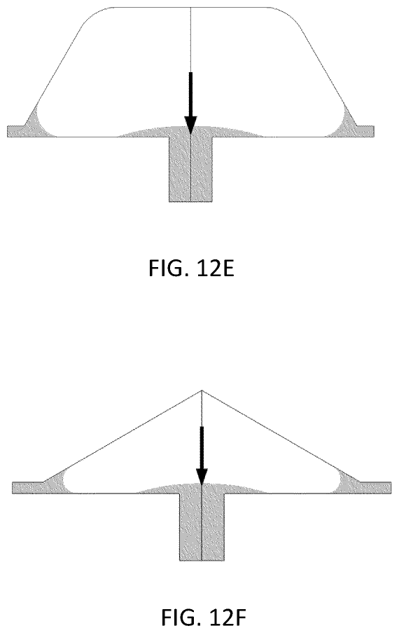

FIGS. 12A to 12F are simulations of the liquid volumes retained in peripheral recesses having different step geometries. The simulations were carried out using the following properties: dynamic viscosity of 0.01 Pas, surface tension of 0.054 N/m, wetted contact angle of 15 degrees, and specific gravity of 1.02. Gravity was in the direction of the arrows shown in FIGS. 12A to 12F. Another parameter varied in these simulations is the angle of the second wall portion 422 to the base 412. Second wall portion angles of 60 degrees (FIGS. 12A to 12E) and 30 degrees (FIG. 12F) were simulated. A further parameter varied in these simulations is the height of the cavity 400. Cavity heights of 2.5 mm (FIGS. 12A to 12D), 3 mm (FIG. 12E) and 2.75 mm (FIG. 12F) were simulated.

FIG. 12A is a simulation of a cavity with a step height of 0.25 mm, a step width of 0.645 mm, a cavity height of 2.5 mm and a second wall portion angle of 60 degrees. With this cavity and step geometry, the cross-sectional area of the liquid within the peripheral recess was 0.311 mm². FIG. 12B is a simulation of a cavity with a step height of 0.375 mm, a step width of 0.375 mm, a cavity height of 2.5 mm and a second wall portion angle of 60 degrees. With this cavity and step geometry, the cross-sectional area of the liquid within the peripheral recess was 0.228 mm². FIG. 12C is a simulation of a cavity with a step height of 0.25 mm, a step width of 0.39 mm, a cavity height of 2.5 mm and a second wall portion angle of 60 degrees. With this cavity and step geometry, the cross-sectional area of the liquid within the peripheral recess was 0.250 mm². FIG. 12D is a simulation of a cavity with a step height of 0.5 mm, a step width of 0.785 mm, a cavity height of 2.5 mm and a second wall portion angle of 60 degrees. With this cavity and step geometry, the cross-sectional area of the liquid within the peripheral recess was 0.238 mm².

FIG. 12E is a simulation of a cavity with a step height of 0.25 mm, a step width of 0.39 mm, and a second wall portion angle of 60 degrees (as with FIG. 12C). However, the cavity height is increased to 3 mm. With this cavity and step geometry, the cross-sectional area of the liquid within the peripheral recess was 0.320 mm². FIG. 12F is a simulation of a cavity with a step height of 0.25 mm, a step width of 0.68 mm, a cavity height of 2.75 mm and a second wall portion angle of 30 degrees. With this cavity and step geometry, the cross-sectional area of the liquid within the peripheral recess was 0.371 mm².

As mentioned above, implementing a peripheral recess 32 allows a cavity (e.g. a capsule) to be emptied when the cavity is “upside-down” (i.e. with the outlet 16 at the top of the cavity 10). The volume of bubble-free liquid emptied from the liquid storage cavity 10 is maximised if the cavity has a sufficiently shallow depth (e.g. no more than 5 mm) such that a vertical liquid column is provided between its upper and lower internal surfaces as a result of the surface tension of the liquid overcoming the force of gravity on the liquid.

FIG. 13A is an example of a liquid storage cavity 500 having an outlet 516 at the top of the cavity 500 (i.e. the base 512 is upwardly disposed, meaning that the liquid storage cavity 500 is upside down). In order to ensure that a liquid column is provided between the upper and lower surfaces, the cavity height (shown in FIG. 13B) should be less than 5 mm, and preferably less than 3.5 mm, more preferably less than 3 mm. Above 5 mm, the surface tension effects are overcome by gravity.

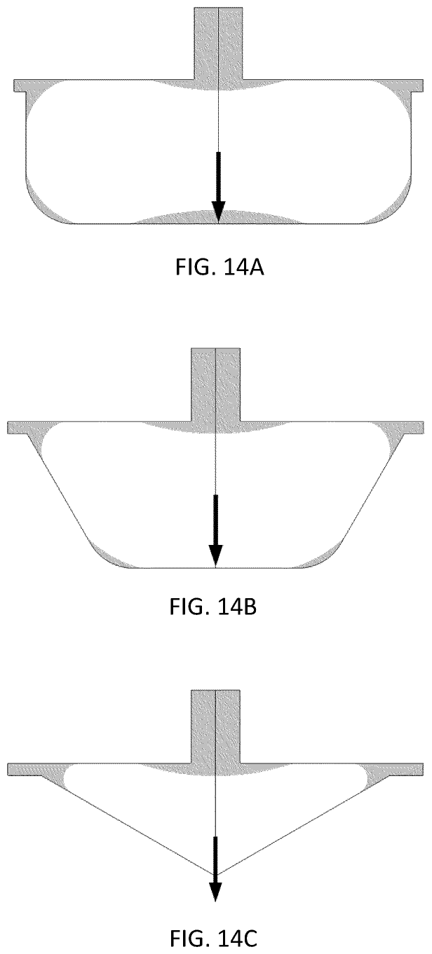

Emptying the cavity 500 in this orientation can result in the formation of a droplet 548 at the bottom of the cavity 500, as shown in FIG. 13A for a cavity with a second wall portion angle of 90 degrees. Liquid also polls in the bottom of the cavity when the second wall portion is 60 degrees, as shown in FIG. 13B. To minimise liquid pooling and droplet formation, the second wall portion angle (illustrated schematically in FIG. 13B) is preferably less than 55 degrees (e.g. as shown in FIG. 14C).

Liquid pooling and droplet formation can also be minimised by ensuring that a flat surface is not provided at the bottom of the cavity (e.g. as also shown in FIG. 14C), or by providing a curved surface at the bottom of the cavity (e.g. as shown in FIGS. 2A to 2D). In other words, liquid pooling and droplet formation is minimised when the second wall portion 524 defines an upper surface of the cavity 500 that is non-parallel to the base.

If the outlet 516 is centrally located at the top of the cavity 500 (i.e. at the centre of the periphery 530 of the cavity 500), then the cross-sectional width to height aspect ratio should be no greater than 5:2 (in other words, the cavity width should be no more than 2.5 times greater than the cavity height).

Although FIGS. 13A and 13B show upside-down emptying of a cavity 500 with a peripheral recess 532 having a step profile, it will be appreciated that cavities with peripheral recesses defined by chamfers and fillets can also be emptied in this configuration, provided that the cavity is sufficiently shallow so that a liquid column forms between the upper and lower surfaces.

FIGS. 14A to 14E are simulations of the liquid volumes retained in peripheral recesses when the cavity is emptied with an outlet 516 at the top of the cavity 500. The simulations were carried out using the following properties: dynamic viscosity of 0.01 Pa·s, surface tension of 0.054 N/m, wetted contact angle of 15 degrees, and specific gravity of 1.02. Gravity was in the direction of the arrows shown in FIGS. 14A to 14E. Another parameter varied in these simulations is the angle of the second wall portion 522 to the base 512. Second wall portion angles of 90 degrees (FIG. 14A), 60 degrees (FIG. 14B) and 30 degrees (FIG. 14C) were simulated. A further parameter varied in these simulations is the height of the cavity 500. Cavity heights of 3 mm (FIGS. 14A and 14B) and 2.75 mm (FIG. 14C) were simulated.

FIG. 14A is a simulation of upside-down emptying of a cavity with a step height of 0.25 mm, a step width of 0.25 mm, a cavity height of 3 mm and a second wall portion angle of 90 degrees. With this cavity and step geometry, the cross-sectional area of the liquid within the peripheral recess was 0.301 mm². FIG. 14B is a simulation of upside-down emptying of a cavity with a step height of 0.25 mm, a step width of 0.39 mm, a cavity height of 3 mm and a second wall portion angle of 60 degrees. With this cavity and step geometry, the cross-sectional area of the liquid within the peripheral recess was 0.314 mm². FIG. 14C is a simulation of a cavity with a step height of 0.25 mm, a step width of 0.68 mm, a cavity height of 2.75 mm and a second wall portion angle of 30 degrees. With this cavity and step geometry, the cross-sectional area of the liquid within the peripheral recess was 0.370 mm².

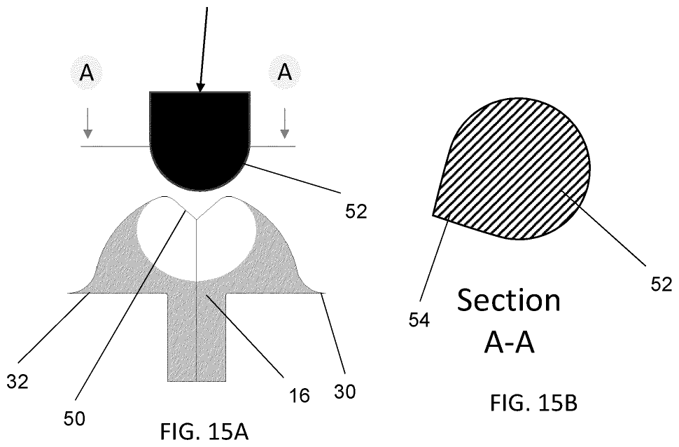

As mentioned above, a liquid bridge is required between the peripheral recess 32 and the outlet 16, in order to ensure that liquid is drawn from the peripheral recess 32 during emptying of the cavity 10. For an outlet 16 that is centrally-located (i.e. at the centre of the periphery 30), one way of providing the liquid bridge is to deform the cavity 10 so that a saddle 50 is provided between the periphery 30 and the outlet 16 (as schematically illustrated in FIG. 15A). The saddle 50 provides a path between the periphery 30 and the outlet 16, along which the upper surface of the cavity 10 has been depressed, such that the distance between the upper and lower surfaces is lower along the saddle 50 than in other regions of the cavity 10. This provides a path for liquid flow between the periphery 30 and the outlet 16, because the surface tension of the liquid retains the liquid along the path defined by the saddle 50.

In order to deform the cavity 10 to provide the saddle 50, an actuator 52 with a ridge 54 may be used when deforming the cavity 10 to create the inlet and outlet. The ridge 54 can be seen from the section view of the actuator 52 shown in FIG. 15B. The actuator may be a component of an analyser device in which a microfluidic cartridge comprising the cavity 10 is received.

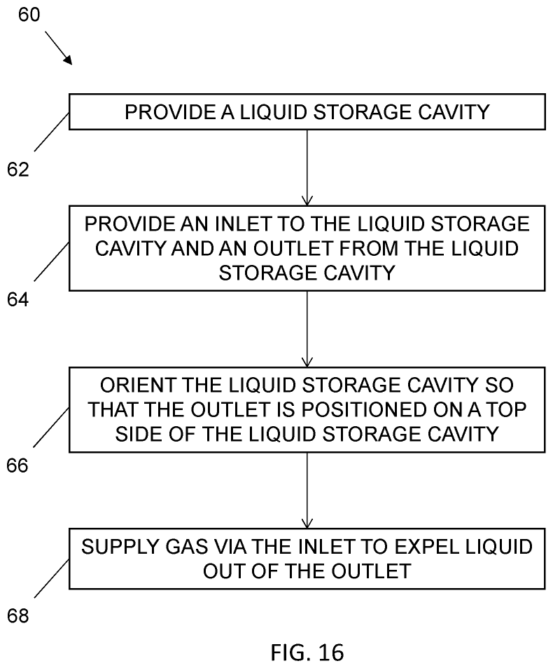

FIG. 16 is a flow diagram of a method 60 of removing liquid from a liquid storage cavity. It will be appreciated that it is not necessary for the features of the method 60 to be carried out in the order depicted in FIG. 16, and that certain steps may be carried out in a different order. As one example, method feature 66 may be carried out prior to method feature 64. Accordingly, the method 60 is not limited to the specific order depicted in FIG. 16 and described below.

At 62, a liquid storage cavity is provided. The liquid storage cavity may be any of the liquid storage cavities described with reference to FIG. 1A to FIG. 15A. For example, the liquid storage cavity may be a capsule (e.g. as shown in FIGS. 2A to 2D), or a chamber (e.g. as shown in FIGS. 6A to 6C). Other examples (e.g. reservoirs, channels, etc.) are also envisioned.

At 64, an inlet to the liquid storage cavity and an outlet from the liquid storage cavity are provided. Providing the outlet from the liquid storage cavity may comprise providing a liquid storage cavity that has a permanent outlet (e.g. in the case of the chamber shown in FIGS. 6A to 6C). Where the liquid storage cavity has a permanent outlet, providing the outlet may further comprise opening a valve in a liquid handling device in which the liquid storage cavity is implemented. Alternatively, providing the outlet from the liquid storage cavity may comprise creating the outlet from the liquid storage cavity. Creating the outlet may comprise deforming the liquid storage cavity to cause rupture of the cavity material (e.g. as described with reference to FIGS. 2A to 2D), or by puncturing the cavity using a puncturing element.

Similarly, providing the inlet to the liquid storage cavity may comprise providing a liquid storage cavity that has a permanent inlet, or creating the inlet to the liquid storage cavity (e.g. by rupturing, puncturing, or otherwise breaking the cavity material).

At 66, the liquid storage cavity is oriented so that the outlet is positioned on a top side of the liquid storage cavity. As explained above, the liquid storage cavity may be oriented in this way prior to providing the inlet and outlet in the liquid storage cavity. As one example, the liquid storage cavity may be implemented in a liquid handling device in this orientation. The liquid handling device may then be received in an analyser device having an actuatable puncture element. Subsequently, the cavity material may be punctured by the puncturing element of the analyser device.

At 68, gas is supplied via the inlet to expel liquid out of the outlet. The gas may, for example, be supplied via a pneumatic actuator in fluidic communication with the inlet. As one example, the inlet to the liquid storage cavity may be in fluidic communication with a pneumatic port of a liquid handling device in which the liquid storage cavity is implemented. The liquid handling device may then be received in an analyser device having a pneumatic supply system. Air may be supplied to the inlet by the pneumatic supply system of the analyser device, via the pneumatic port of the liquid handling device.

The gas displaces the liquid in the liquid storage cavity. Liquid is drawn into the peripheral recess of the liquid storage cavity by capillary action. The liquid in the peripheral recess provides a continuous feed path from other volumes of the liquid storage cavity to the outlet, thereby maximising the amount of bubble-free liquid expelled from the liquid storage cavity.

In some implementations, the peripheral recess 32 may not extend around the entire periphery of the cavity 10. In addition, combinations of step, chamfer and fillet profiles may be used to define the peripheral recess 32.

Although the above discussion focusses on capsules and chambers as examples of cavities that may comprise peripheral recesses, the peripheral recess may also be included in other fluidic components, such as channels. When incorporated into a channel, the peripheral recess aids liquid flow through the channel.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

Annex 1: Cross-sectional areas of liquid retained in peripheral
recess for different liquid properties and fillet radii

| | | | | | Cross- |
|---|---|---|---|---|---|
| | | | | | sectional |
| | Solution | Wetted | | | area of |
| Fillet | surface | contact | Solution | | retained |
| radius | tension | angle | viscosity | Gravity | solution |
| (mm) | (N/m) | (deg) | (Pa*s) | direction | (mm²) |
| 0.6 | 0.018175 | 20 | 0.005 | −1 | 0.10978 |
| 0.6 | 0.018175 | 20 | 0.005 | 1 | 0.1096 |
| 0.6 | 0.018175 | 20 | 0.01 | −1 | 0.10965 |
| 0.6 | 0.018175 | 20 | 0.01 | 1 | 0.10952 |
| 0.6 | 0.018175 | 20 | 0.015 | −1 | 0.10958 |
| 0.6 | 0.018175 | 20 | 0.015 | 1 | 0.10945 |
| 0.6 | 0.018175 | 30 | 0.005 | −1 | 0.10926 |
| 0.6 | 0.018175 | 30 | 0.005 | 1 | 0.10928 |
| 0.6 | 0.018175 | 30 | 0.01 | −1 | 0.10917 |
| 0.6 | 0.018175 | 30 | 0.01 | 1 | 0.10915 |
| 0.6 | 0.018175 | 30 | 0.015 | −1 | 0.10913 |
| 0.6 | 0.018175 | 30 | 0.015 | 1 | 0.10906 |
| 0.6 | 0.018175 | 40 | 0.005 | −1 | 0.10857 |
| 0.6 | 0.018175 | 40 | 0.005 | 1 | 0.10856 |
| 0.6 | 0.018175 | 40 | 0.01 | −1 | 0.10847 |
| 0.6 | 0.018175 | 40 | 0.01 | 1 | 0.10847 |
| 0.6 | 0.018175 | 40 | 0.015 | −1 | 0.10841 |
| 0.6 | 0.018175 | 40 | 0.015 | 1 | 0.10842 |
| 0.6 | 0.03635 | 20 | 0.005 | −1 | 0.11079 |
| 0.6 | 0.03635 | 20 | 0.005 | 1 | 0.11071 |
| 0.6 | 0.03635 | 20 | 0.01 | −1 | 0.11055 |
| 0.6 | 0.03635 | 20 | 0.01 | 1 | 0.11049 |
| 0.6 | 0.03635 | 20 | 0.015 | −1 | 0.11052 |
| 0.6 | 0.03635 | 20 | 0.015 | 1 | 0.11045 |
| 0.6 | 0.03635 | 30 | 0.005 | −1 | 0.10994 |
| 0.6 | 0.03635 | 30 | 0.005 | 1 | 0.11 |
| 0.6 | 0.03635 | 30 | 0.01 | −1 | 0.10975 |
| 0.6 | 0.03635 | 30 | 0.01 | 1 | 0.10988 |
| 0.6 | 0.03635 | 30 | 0.015 | −1 | 0.10985 |
| 0.6 | 0.03635 | 30 | 0.015 | 1 | 0.10974 |
| 0.6 | 0.03635 | 40 | 0.005 | −1 | 0.109 |
| 0.6 | 0.03635 | 40 | 0.005 | 1 | 0.10901 |
| 0.6 | 0.03635 | 40 | 0.01 | −1 | 0.10892 |
| 0.6 | 0.03635 | 40 | 0.01 | 1 | 0.10891 |
| 0.6 | 0.03635 | 40 | 0.015 | −1 | 0.10886 |
| 0.6 | 0.03635 | 40 | 0.015 | 1 | 0.10882 |
| 0.6 | 0.054525 | 20 | 0.005 | −1 | 0.11154 |
| 0.6 | 0.054525 | 20 | 0.005 | 1 | 0.11157 |
| 0.6 | 0.054525 | 20 | 0.01 | −1 | 0.11136 |
| 0.6 | 0.054525 | 20 | 0.01 | 1 | 0.11123 |
| 0.6 | 0.054525 | 20 | 0.015 | −1 | 0.11123 |
| 0.6 | 0.054525 | 20 | 0.015 | 1 | 0.11125 |
| 0.6 | 0.054525 | 30 | 0.005 | −1 | 0.11058 |
| 0.6 | 0.054525 | 30 | 0.005 | 1 | 0.11051 |
| 0.6 | 0.054525 | 30 | 0.01 | −1 | 0.11037 |
| 0.6 | 0.054525 | 30 | 0.01 | 1 | 0.11066 |
| 0.6 | 0.054525 | 30 | 0.015 | −1 | 0.11036 |
| 0.6 | 0.054525 | 30 | 0.015 | 1 | 0.11026 |
| 0.6 | 0.054525 | 40 | 0.005 | −1 | 0.10961 |
| 0.6 | 0.054525 | 40 | 0.005 | 1 | 0.10941 |
| 0.6 | 0.054525 | 40 | 0.01 | −1 | 0.10929 |
| 0.6 | 0.054525 | 40 | 0.01 | 1 | 0.10925 |
| 0.6 | 0.054525 | 40 | 0.015 | −1 | 0.10921 |
| 0.6 | 0.054525 | 40 | 0.015 | 1 | 0.10921 |
| 0.4 | 0.018175 | 20 | 0.005 | −1 | 0.081887 |
| 0.4 | 0.018175 | 20 | 0.005 | 1 | 0.081925 |
| 0.4 | 0.018175 | 20 | 0.01 | −1 | 0.081782 |
| 0.4 | 0.018175 | 20 | 0.01 | 1 | 0.081694 |
| 0.4 | 0.018175 | 20 | 0.015 | −1 | 0.081765 |
| 0.4 | 0.018175 | 20 | 0.015 | 1 | 0.081607 |
| 0.4 | 0.018175 | 30 | 0.005 | −1 | 0.0817 |
| 0.4 | 0.018175 | 30 | 0.005 | 1 | 0.081739 |
| 0.4 | 0.018175 | 30 | 0.01 | −1 | 0.081485 |
| 0.4 | 0.018175 | 30 | 0.01 | 1 | 0.081532 |
| 0.4 | 0.018175 | 30 | 0.015 | −1 | 0.081485 |
| 0.4 | 0.018175 | 30 | 0.015 | 1 | 0.081532 |
| 0.4 | 0.018175 | 40 | 0.005 | −1 | 0.081404 |
| 0.4 | 0.018175 | 40 | 0.005 | 1 | 0.081321 |
| 0.4 | 0.018175 | 40 | 0.01 | −1 | 0.081283 |
| 0.4 | 0.018175 | 40 | 0.01 | 1 | 0.081266 |
| 0.4 | 0.018175 | 40 | 0.015 | −1 | 0.081324 |
| 0.4 | 0.018175 | 40 | 0.015 | 1 | 0.081223 |
| 0.4 | 0.03635 | 20 | 0.01 | −1 | 0.082129 |
| 0.4 | 0.03635 | 20 | 0.01 | 1 | 0.08228 |
| 0.4 | 0.03635 | 20 | 0.015 | −1 | 0.08205 |
| 0.4 | 0.03635 | 20 | 0.015 | 1 | 0.082135 |
| 0.4 | 0.03635 | 30 | 0.005 | −1 | 0.082005 |
| 0.4 | 0.03635 | 30 | 0.005 | 1 | 0.082035 |
| 0.4 | 0.03635 | 30 | 0.01 | −1 | 0.081892 |
| 0.4 | 0.03635 | 30 | 0.01 | 1 | 0.081917 |
| 0.4 | 0.03635 | 30 | 0.015 | −1 | 0.081747 |
| 0.4 | 0.03635 | 30 | 0.015 | 1 | 0.081853 |
| 0.4 | 0.03635 | 40 | 0.005 | −1 | 0.081643 |
| 0.4 | 0.03635 | 40 | 0.005 | 1 | 0.081628 |
| 0.4 | 0.03635 | 40 | 0.01 | −1 | 0.081546 |
| 0.4 | 0.03635 | 40 | 0.01 | 1 | 0.081461 |
| 0.4 | 0.03635 | 40 | 0.015 | −1 | 0.081546 |
| 0.4 | 0.03635 | 40 | 0.015 | 1 | 0.081479 |
| 0.4 | 0.054525 | 20 | 0.01 | 1 | 0.082529 |
| 0.4 | 0.054525 | 20 | 0.015 | −1 | 0.08242 |
| 0.4 | 0.054525 | 20 | 0.015 | 1 | 0.0825 |
| 0.4 | 0.054525 | 30 | 0.005 | −1 | 0.082349 |
| 0.4 | 0.054525 | 30 | 0.005 | 1 | 0.082281 |
| 0.4 | 0.054525 | 30 | 0.01 | 1 | 0.082164 |
| 0.4 | 0.054525 | 30 | 0.015 | −1 | 0.082122 |
| 0.4 | 0.054525 | 30 | 0.015 | 1 | 0.081968 |
| 0.4 | 0.054525 | 40 | 0.005 | −1 | 0.08177 |
| 0.4 | 0.054525 | 40 | 0.005 | 1 | 0.081787 |
| 0.4 | 0.054525 | 40 | 0.01 | −1 | 0.081662 |
| 0.4 | 0.054525 | 40 | 0.01 | 1 | 0.081683 |
| 0.4 | 0.054525 | 40 | 0.015 | −1 | 0.081628 |
| 0.4 | 0.054525 | 40 | 0.015 | 1 | 0.081606 |
| 0.2 | 0.018175 | 20 | 0.005 | −1 | 0.063109 |
| 0.2 | 0.018175 | 20 | 0.005 | 1 | 0.06305 |
| 0.2 | 0.018175 | 20 | 0.01 | −1 | 0.062921 |
| 0.2 | 0.018175 | 20 | 0.01 | 1 | 0.062977 |
| 0.2 | 0.018175 | 20 | 0.015 | −1 | 0.062835 |
| 0.2 | 0.018175 | 20 | 0.015 | 1 | 0.062827 |
| 0.2 | 0.018175 | 30 | 0.005 | −1 | 0.062843 |
| 0.2 | 0.018175 | 30 | 0.005 | 1 | 0.062751 |
| 0.2 | 0.018175 | 30 | 0.01 | −1 | 0.062743 |
| 0.2 | 0.018175 | 30 | 0.01 | 1 | 0.062618 |
| 0.2 | 0.018175 | 30 | 0.015 | −1 | 0.062692 |
| 0.2 | 0.018175 | 30 | 0.015 | 1 | 0.062576 |
| 0.2 | 0.018175 | 40 | 0.005 | −1 | 0.062395 |
| 0.2 | 0.018175 | 40 | 0.005 | 1 | 0.062393 |
| 0.2 | 0.018175 | 40 | 0.01 | −1 | 0.062328 |
| 0.2 | 0.018175 | 40 | 0.01 | 1 | 0.062304 |
| 0.2 | 0.018175 | 40 | 0.015 | −1 | 0.062323 |
| 0.2 | 0.018175 | 40 | 0.015 | 1 | 0.062224 |
| 0.2 | 0.03635 | 20 | 0.005 | −1 | 0.06346 |
| 0.2 | 0.03635 | 20 | 0.005 | 1 | 0.063404 |
| 0.2 | 0.03635 | 20 | 0.01 | −1 | 0.063361 |
| 0.2 | 0.03635 | 20 | 0.01 | 1 | 0.063329 |
| 0.2 | 0.03635 | 20 | 0.015 | −1 | 0.063255 |
| 0.2 | 0.03635 | 20 | 0.015 | 1 | 0.063206 |
| 0.2 | 0.03635 | 30 | 0.005 | −1 | 0.063152 |
| 0.2 | 0.03635 | 30 | 0.005 | 1 | 0.063059 |
| 0.2 | 0.03635 | 30 | 0.01 | −1 | 0.06289 |
| 0.2 | 0.03635 | 30 | 0.01 | 1 | 0.062889 |
| 0.2 | 0.03635 | 30 | 0.015 | −1 | 0.062882 |
| 0.2 | 0.03635 | 30 | 0.015 | 1 | 0.062789 |
| 0.2 | 0.03635 | 40 | 0.005 | −1 | 0.062728 |
| 0.2 | 0.03635 | 40 | 0.005 | 1 | 0.06264 |
| 0.2 | 0.03635 | 40 | 0.01 | −1 | 0.062369 |
| 0.2 | 0.03635 | 40 | 0.01 | 1 | 0.062529 |
| 0.2 | 0.03635 | 40 | 0.015 | −1 | 0.062369 |
| 0.2 | 0.03635 | 40 | 0.015 | 1 | 0.062337 |
| 0.2 | 0.054525 | 20 | 0.005 | −1 | 0.063878 |
| 0.2 | 0.054525 | 20 | 0.005 | 1 | 0.063899 |
| 0.2 | 0.054525 | 20 | 0.01 | −1 | 0.063713 |
| 0.2 | 0.054525 | 20 | 0.01 | 1 | 0.063545 |
| 0.2 | 0.054525 | 20 | 0.015 | −1 | 0.063542 |
| 0.2 | 0.054525 | 20 | 0.015 | 1 | 0.06345 |
| 0.2 | 0.054525 | 30 | 0.005 | −1 | 0.063433 |
| 0.2 | 0.054525 | 30 | 0.005 | 1 | 0.063468 |
| 0.2 | 0.054525 | 30 | 0.01 | −1 | 0.063269 |
| 0.2 | 0.054525 | 30 | 0.01 | 1 | 0.063258 |
| 0.2 | 0.054525 | 30 | 0.015 | −1 | 0.063225 |
| 0.2 | 0.054525 | 30 | 0.015 | 1 | 0.063113 |
| 0.2 | 0.054525 | 40 | 0.005 | −1 | 0.062911 |
| 0.2 | 0.054525 | 40 | 0.005 | 1 | 0.062814 |
| 0.2 | 0.054525 | 40 | 0.01 | −1 | 0.062726 |
| 0.2 | 0.054525 | 40 | 0.01 | 1 | 0.062849 |
| 0.2 | 0.054525 | 40 | 0.015 | −1 | 0.062663 |
| 0.2 | 0.054525 | 40 | 0.015 | 1 | 0.062479 |

1. A liquid storage cavity, comprising:
a base;
one or more walls extending from the base, wherein the liquid storage cavity has a volume defined by the base and the one or more walls; and
a periphery at which the one or more walls are joined to the base, wherein at least a portion of the periphery includes a peripheral recess defined by the base and at least one of the one or more walls, wherein the peripheral recess is configured to house a volume of liquid.

2. A liquid storage cavity according to claim 1, wherein the at least one of the one or more walls extends outwardly from an interior of the liquid storage cavity to define the peripheral recess.

3. A liquid storage cavity according to claim 1 or claim 2, wherein the at least one of the one or more walls comprises:
a first wall portion and a second wall portion, wherein the first wall portion extends between the base and the second wall portion around the portion of the periphery;
wherein the second wall portion extends from the first wall portion in a direction away from the base.

4. A liquid storage cavity according to claim 3, wherein the first wall portion defines a fillet between the second wall portion and the base.

5. A liquid storage cavity according to claim 4, wherein the radius of the fillet defined by the first wall portion is between 0.15 mm and 1 mm.

6. A liquid storage cavity according to claim 5, wherein the radius of the fillet defined by the first wall portion is between 0.2 mm and 0.6 mm.

7. A liquid storage cavity according to claim 3, wherein the first wall portion extends at an acute angle between the base and the second wall portion, such that the peripheral recess has a triangular cross-section.

8. A liquid storage cavity according to claim 7, wherein the acute angle between the first wall portion and the base is less than or equal to 45 degrees.

9. A liquid storage cavity according to claim 7 or claim 8, wherein the first wall portion extends laterally beyond a join between the first wall portion and the second wall portion by a distance of less than or equal to 0.5 mm.

10. A liquid storage cavity according to claim 3, wherein the first wall portion comprises a first part and a second part;
wherein the first part of the first wall portion is joined to the second wall portion and extends outwardly from an interior of the liquid storage cavity in a direction substantially parallel to the base; and
the second part of the first wall portion extends between the first part and the base, such that the elongate recess has a quadrilateral cross-section.

11. A liquid storage cavity according to claim 10, wherein the first part of the first wall portion has a width of less than or equal to 0.5 mm.

12. A liquid storage cavity according to claim 10 or claim 11, wherein the second part of the second wall portion has a height of less than or equal to 0.5 mm.

13. A liquid storage cavity according to any of claims 3 to 12, wherein the liquid storage cavity is a capsule.

14. A liquid storage cavity according to claim 13, wherein the height of the liquid storage cavity is less than or equal to 5 mm.

15. A liquid storage cavity according to claim 14, wherein the height of the liquid storage cavity is less than or equal to 3.5 mm.

16. A liquid storage cavity according to any of claims 3 to 15, wherein the second wall portion extends away from the base in a direction substantially perpendicular to the base.

17. A liquid storage cavity according to any of claims 1 to 16, wherein the peripheral recess extends around the entire periphery of the liquid storage cavity.

18. A liquid storage cavity according to any of claims 1 to 17, further comprising an outlet in the base.

19. A liquid storage cavity according to claim 18, wherein the outlet is coincident with the portion of the periphery.

20. A method of removing liquid from a liquid storage cavity, the method comprising:
providing a liquid storage cavity according to any of claims 1 to 19;
providing an inlet to the liquid storage cavity and an outlet from the liquid storage cavity;
orienting the liquid storage cavity so that the outlet is positioned on a top side of the liquid storage cavity; and
supplying gas via the inlet to expel liquid out of the outlet.

21. A method according to claim 20, wherein providing the outlet from the liquid storage cavity comprises providing a liquid storage cavity according to claim 18 or claim 19.

22. A method according to claim 20, wherein providing the outlet from the liquid storage cavity comprises creating the outlet in the base of the liquid storage cavity.
